(19) United States
(12) Patent Application Publication
(10) Pub. No.: US 2025/0347428 A1
(43) Pub. Date: Nov. 13, 2025

(54) HYBRID DRYING SYSTEM

(71) Applicant: Honeywell Federal Manufacturing & Technologies, LLC, Kansas City, MO (US)

(72) Inventors: Clayton J. Dodd, Kansas City, MO (US); Trent Trutzel, Kansas City, MO (US)

(21) Appl. No.: 19/206,710

(22) Filed: May 13, 2025

Related U.S. Application Data
(60) Provisional application No. 63/646,042, filed on May 13, 2024.

(51) Int. Cl. F24F 3/14; B01D 53/02; B01D 53/26; B01D 53/30

(52) U.S. Cl. CPC F24F 3/1411; B01D 53/02; B01D 53/261; B01D 53/265; B01D 53/30; B01D 2257/80; B01D 2258/06

(57) ABSTRACT

A hybrid drying system for treating process air entering a climate controlled system. The hybrid drying system includes a desiccant dryer, an environmental control unit (ECU), and a smart nitrogen control system. The desiccant dryer is configured to remove moisture from the process air. The ECU includes a condenser fluidly connected to the desiccant dryer and configured to further remove moisture from the process air. The smart nitrogen control system is configured to reduce an oxygen level of the process air via selective injection of nitrogen into the process air.

### RELATED APPLICATIONS

This regular utility non-provisional patent application claims priority benefit of earlier-filed U.S. Provisional Patent Application Ser. No. 63/646,042, filed on May 13, 2024, and entitled “HYBRID DRYING SYSTEM”. The identified earlier-filed provisional patent application is hereby incorporated by reference in its entirety into the present patent application.

### STATEMENT REGARDING FEDERALLY-SPONSORED RESEARCH OR DEVELOPMENT

This invention was made with Government support under Contract No.: DE-NA-0002839 awarded by the United States Department of Energy/National Nuclear Security Administration. The Government has certain rights in the invention.

### BACKGROUND

Climate controlled storage systems such as high efficiency material storage systems (HEMSS) often manage a relative humidity (RH) level and electrostatic discharge (ESD) and use nitrogen to control an oxygen level. A nitrogen utility may be connected to an HEMSS with a flow of 32 SCFM twenty-four hours a day, seven days a week. This results in significant nitrogen consumption.

### SUMMARY OF THE INVENTION

Embodiments of the present invention solve the above-mentioned problems and other problems and provide a distinct advance in the art of climate controlled storage systems. More particularly, the present invention provides a hybrid drying system that reduces consumables (e.g., nitrogen), improves safety, economizes the use of existing or new climate controlled storage systems, and ensures ESD compliance.

An embodiment of the present invention is a hybrid drying system for treating process air entering a climate controlled system. The hybrid drying system includes a desiccant dryer, an environmental control unit (ECU), and a control panel including a smart nitrogen control system. The desiccant dryer is configured to remove moisture from the process air. The ECU includes a condenser fluidly connected to the desiccant dryer and configured to further remove moisture from the process air. The smart nitrogen control system is configured to reduce an oxygen level of the process air via selective injection of nitrogen into the process air.

Another embodiment of the present invention is a hybrid drying system for treating process air entering a climate controlled system. The hybrid drying system includes a desiccant dryer, an ECU, and a controller including a smart nitrogen control system. The desiccant dryer is configured to remove moisture from the process air. The ECU includes a condenser fluidly connected to the desiccant dryer and configured to further remove moisture from the process air. The ECU is connected inline with the desiccant dryer thereby optimizing airflow therebetween. The smart nitrogen control system is configured to reduce an oxygen level of the process air via selective injection of nitrogen into the process air.

Another embodiment of the present invention is a standalone ECU and nitrogen system for treating process air entering a climate controlled system. The standalone ECU and nitrogen system includes a condenser, a temperature sensor, a relative humidity sensor, an on/off switch, an emergency off (EMO) switch, and a smart nitrogen control system. The condenser is configured to remove moisture from the process air. The temperature sensor is configured to detect a temperature of the process air, wherein the ECU is configured to control the condenser to change the temperature of the process air based on an output of the temperature sensor. The relative humidity sensor is configured to detect a relative humidity of the process air, wherein the ECU is further configured to control the condenser to a moisture level of the process air based on an output of the relative humidity sensor. The on/off switch allows for manual activation of the ECU. The EMO switch automatically deactivates the ECU upon detection of an emergency condition. The condenser is configured to reduce the moisture level of the process air to less than 18 percent relative humidity. The smart nitrogen control system is configured to reduce an oxygen level of the process air via selective injection of nitrogen into the process air.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is a perspective view of a hybrid drying system constructed in accordance with an embodiment of the present invention, with a climate controlled storage system;

FIG. 2 is a top plan view of the hybrid drying system of FIG. 1;

FIG. 3 is a perspective view of the hybrid drying system of FIG. 1;

FIG. 4 is a side elevation view of the hybrid drying system of FIG. 1;

FIG. 5 is another side elevation view of the hybrid drying system of FIG. 1;

FIG. 6 is a top plan view of the hybrid drying system of FIG. 1;

FIG. 7 is a schematic diagram of certain components of the hybrid drying system of FIG. 1;

FIG. 8 is a perspective view of a hybrid drying system constructed in accordance with another embodiment of the present invention, in a climate controlled storage system;

FIG. 9 is a perspective view of the hybrid drying system of FIG. 8;

FIG. 10 is a side elevation view of the hybrid drying system of FIG. 8;

FIG. 11 is another side elevation view of the hybrid drying system of FIG. 8;

FIG. 12 is a top plan view of the hybrid drying system of FIG. 8;

FIG. 13 is a perspective view of an ECU constructed in accordance with another embodiment of the present invention;

FIG. 14 is a side elevation view of the ECU of FIG. 13;

FIG. 15 is another side elevation view of the ECU of FIG. 13; and

FIG. 16 is a top plan view of the ECU of FIG. 13.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

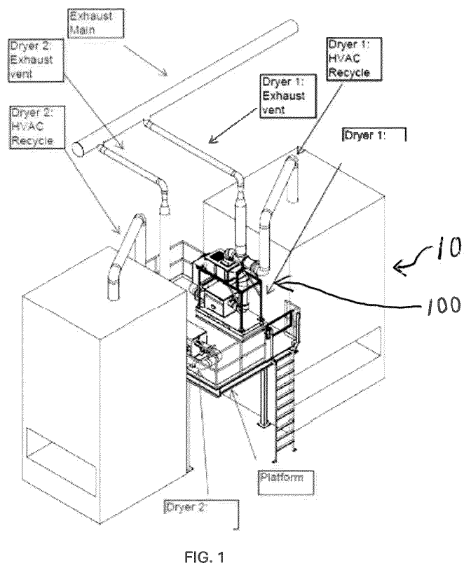

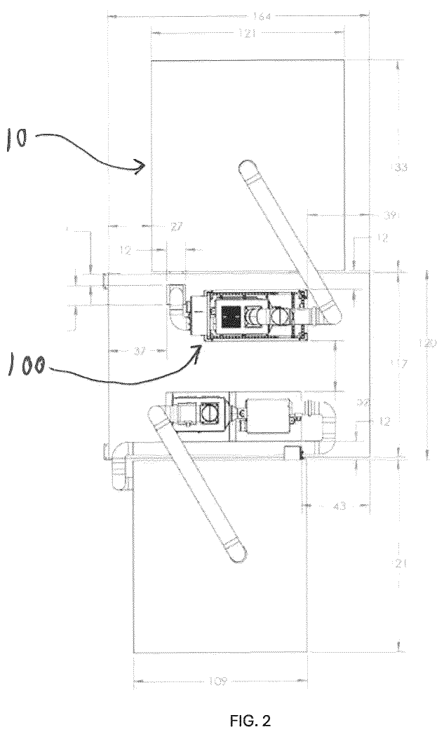

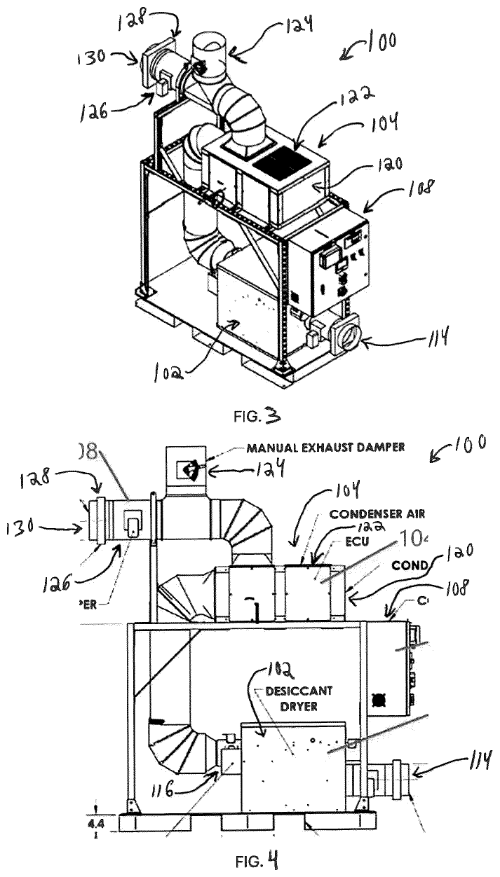

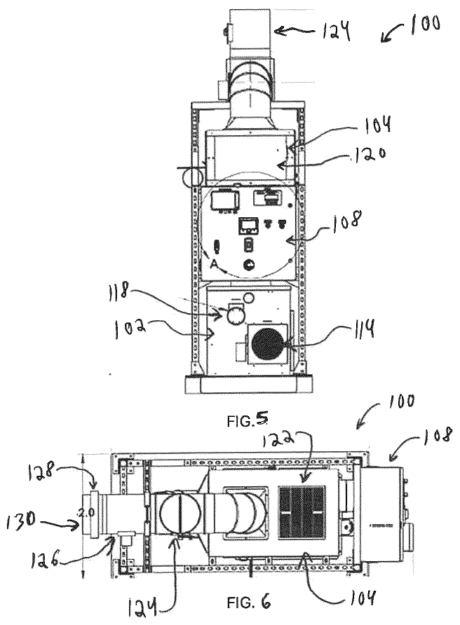

Turning to FIGS. 1-7, a hybrid drying system 100 constructed in accordance with an embodiment of the invention will now be described in detail. The hybrid drying system 100 may be used with a climate controlled storage system such as an automated vertical lift module 10 (FIG. 1). The hybrid drying system 100 is shown mounted externally from the vertical lift module 10 on a platform, but the hybrid drying system 10 may alternatively be installed inside the climate controlled storage system.

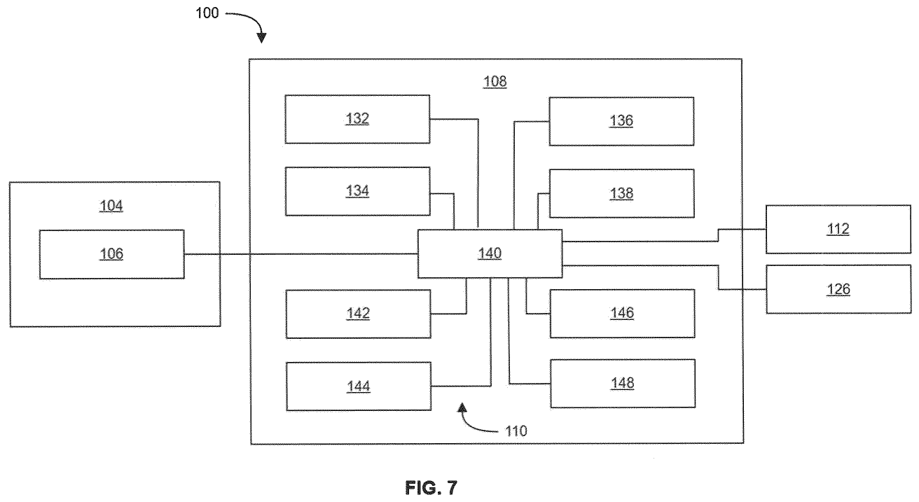

The hybrid drying system 100 broadly comprises a desiccant dryer 102, an environmental control unit (ECU) 104 including a condenser 106 (FIG. 7), and a control panel 108 including a plurality of sensors 110 (FIG. 7) and a smart nitrogen control system 148. The hybrid drying system 100 may also include a fire suppression controller 112 (FIG. 7), a process air inlet 114, a react air inlet 116, react air discharge 118, a condenser air inlet 120, condenser air discharge 122, a manual exhaust damper 124, a dynamic isolation damper 126, a fire damper 128, and a process air discharge 130. The hybrid drying system 100 may be air cooled or water cooled. The hybrid drying system 100 may be fully integrated with the vertical lift module 10 and may provide temperature, relative humidity, and oxygen control with ventilated exhaust infrastructure located within the structural envelope of the vertical lift module 10 without impeding the automated picking system.

The desiccant dryer 102 may be the first air treating component of the hybrid drying system 100 and draws bulk air (hereinafter “process air”) through the process air inlet 114. Air drawn in through the process air inlet 114 enters the desiccant dryer 102 and flows through the rest of the hybrid drying system 100. Moisture is removed from the process air via air drawn from the react air inlet 116 to the react air discharge 118, which are fluidly connected to the desiccant dryer 102. The desiccant dryer 102 may reduce a moisture level of the process air so that the final RH (after conditioning by the ECU) of the process air is less than 5 percent RH. The desiccant dryer 102 may include a silica rotor that is replaced when it becomes saturated. Alternatively, the desiccant dryer 102 may be a regenerative desiccant dryer in which a different desiccant material is used that allows batches of operative material. That is, a second batch may be shifted to an operative position while a first batch is drying out and vice versa, thus resulting in an “infinite” system. The desiccant dryer 102 may use silica gel, clay, activated alumina, molecular sieves, and the like for drawing moisture.

The ECU 104 controls the condenser 106 so that the condenser 106 cools the dry process air from the desiccant dryer 102. Cooling via the ECU 104 helps maintain temperature setpoints of the process air. An additional benefit of the ECU 104 is removing moisture from the process air after the process air is initially treated by the desiccant dryer 102. To that end, the ECU 104 may be activated via internal controls or controls of the control panel 108. The ECU 104 may be positioned above the desiccant dryer 102 and may be fluidly connected thereto via a non-linear duct having two elbows, for example.

The condenser 106 may be downstream from the desiccant dryer 102 and may be configured to cool the process air and “air dry” the process air to less than 18 percent RH. The condenser 106 may include a compressor, evaporator coils, condenser coils, and the like for drawing condensation from the process air. The condenser 106 may also include the aforementioned condenser air inlet 120 and condenser air outlet 122.

The condenser air inlet 120 is fluidly connected to a condenser of the ECU 104. Air drawn in through the condenser air inlet 120 enters the condenser 106 of the ECU 104 to draw humidity from the process air. The condenser air outlet 122 is fluidly connected to the condenser 106 and discharges humidified air therefrom.

The control panel 108 may include sensors 110, an ECU on/off switch 132, a “fan only” switch 134, an emergency off (EMO) switch 136, a disconnect switch 138, a controller 140, and the aforementioned smart nitrogen control system 148.

The sensors 110 may include one or more oxygen sensors 142, temperature sensors 144, RH sensors 146, and the like for detecting an oxygen level, a temperature, and an RH of the process air. Some of the sensors 110 may be positioned upstream of the desiccant dryer 102, between the desiccant dryer 102 and the condenser 106, downstream of the condenser 106, or any combination thereof.

The temperature sensor 144 may be configured to detect a temperature of the process air. The controller 140 may then control the condenser 106 to change the temperature of the process air based on an output of the temperature sensor 144.

The RH sensor 146 may be configured to detect a relative humidity of the process air. The controller 140 may then control the condenser 106 to change the relative humidity of the process air based on an output of the RH sensor 146.

The ECU on/off switch 132 activates the ECU 104 when actuated. The fan only switch 134 exclusively activates a circulating fan when actuated. The EMO switch 136 deactivates all components when activated, which may be used when an immediate shutdown is desired. The disconnect switch 138 may be used to effectively deactivate certain components of the hybrid drying system 100. The above switches may be manually operated and/or may have automated actuation. For example, the EMO switch 136 may be automatically activated to shut off the hybrid drying system 100 or components thereof when the smart nitrogen control system 148 determines an emergency condition exists.

The controller 140 may control the desiccant dryer 102, the ECU 104, and the various dampers described below. To that end, the controller 140 may comprise one or more processors that includes electronic hardware components such as microprocessors (single-core or multi-core), microcontrollers, digital signal processors (DSPs), field-programmable gate arrays (FPGAs), analog and/or digital application-specific integrated circuits (ASICs), intelligence circuitry, or the like, or combinations thereof. The controller 140 may generally execute, process, or run instructions, code, code segments, code statements, software, firmware, programs, applications, apps, processes, services, daemons, or the like. The controller 140 may also include hardware components such as registers, finite-state machines, sequential and combinational logic, configurable logic blocks, and other electronic circuits that can perform the functions necessary for the operation of the current invention. In certain embodiments, the controller 140 may include multiple computational components and functional blocks that are packaged separately but function as a single unit. In some embodiments, the controller 140 may further include multiprocessor architectures, parallel processor architectures, processor clusters, and the like, which provide high performance computing. The controller 140 may be communicatively connected to the sensors 110 and to the various controlled components via universal busses, address busses, data busses, control lines, and the like. In addition, the controller 140 may include analog to digital converters (ADCs) to convert analog electronic signals to streams of digital data values and/or digital to analog converters (DACs) to convert streams of digital data values to analog electronic signals. In one embodiment, the controller 140 is a Watlow F4T controller.

Some of the control functions described herein may be implemented with one or more computer programs executed by the controller 140. Each computer program comprises an ordered listing of executable instructions for implementing logical functions and can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any means that can contain, store, communicate, propagate or transport the program for use by or in connection with the instruction execution system, apparatus, or device including, but not limited to, a memory as described below. The computer-readable medium can be, for example, but not limited to, an electronic, magnetic, optical, electro-magnetic, infrared, or semi-conductor system, apparatus, device, or propagation medium. More specific, although not inclusive, examples of the computer-readable medium would include the following: an electrical connection having one or more wires, a random access memory (RAM), a read-only memory (ROM), an erasable, programmable, read-only memory (EPROM or Flash memory), an optical fiber, and a portable compact disk read-only memory (CDROM).

The memory may be any electronic memory that can be accessed by the controller 140 and operable for storing instructions or data. The memory may be integral with the controller 140 or may be external memory accessible by the controller 140. The memory may be a single component or may be a combination of components that provide the requisite functionality. The memory may include various types of volatile or non-volatile memory such as flash memory, optical discs, magnetic storage devices, SRAM, DRAM, or other memory devices capable of storing data and instructions. The memory may communicate directly with the computing device or may communicate over a bus or other mechanism that facilitates direct or indirect communication. The memory may optionally be structured with a file system to provide organized access to data existing thereon.

The controller 140 may generate data from signals received from the sensors and other components of the hybrid drying system 100. The data may be stored on the memory and compiled or analyzed. The hybrid drying system 100 may then be controlled or operated based on the analysis to more efficiently and effectively manage the climate of the vertical lift module 10.

The smart nitrogen control system 148 reduces oxygen in the process air to less than 500 ppm. The smart nitrogen control system 148 may be configured to activate nitrogen injection into the process air so that nitrogen only flows when an oxygen sensor detects greater than 500 ppm oxygen. This results in a significant reduction in nitrogen consumption when the storage system is not in use.

The fire suppression controller 112 may control the fire damper 128. To that end, the fire suppression controller 112 may be configured to determine a fire condition or potential fire condition and actuate the fire damper 128.

The manual exhaust damper 124 may be connected to the process air duct via a T-joint between the ECU 104 and the process air discharge 130 for venting exhaust as desired. In one embodiment, the manual exhaust damper 124 may be the highest point of the hybrid drying system 100.

The dynamic isolation damper 126 may be a motorized damper near the process air discharge 130 for controlling airflow to the VLM 10. To that end, the dynamic isolation damper 126 may be communicatively coupled to the controller 140.

The fire damper 128 may be positioned near the process air discharge 130. The fire damper 128 may be activated by the fire suppression controller 112 upon detection of a fire condition or potential fire condition.

The process air discharge 130 may be connected to (or may open to) the interior of the VLM 10 for releasing the treated air thereto. In one embodiment, the process air discharge 130 may be elevated relative to the process air inlet 114.

The above-described invention provides several advantages. For example, the hybrid drying system 100 utilizes nitrogen for controlling an oxygen level. The hybrid drying system 100 also utilizes a desiccant dryer and ECU control for controlling a relative humidity level and a temperature level. The hybrid drying system 100 also complies with electrostatic discharge (ESD) requirements. The hybrid drying system 100 significantly reduces the use of nitrogen in inert storage systems such as climate controlled storage system and eliminates a high hazard work environment. The hybrid drying system 100 results in less than 5 percent RH and less than 500 ppm oxygen.

The hybrid drying system 100 may be retrofitted to existing climate controlled storage systems or part of an integrated storage system. Retrofitting an existing climate controlled storage system is low cost, highly adaptable, and easy to maintain. One embodiment may be ideal for strict air quality requirements such as less than 5 percent RH, less than 500 ppm O₂, and ESD approved. Such an embodiment may have high efficiency (e.g., 15 minute process time), but potentially a larger footprint (e.g., 780 lbs).

The hybrid drying system 100 eliminates the need to purge storage systems. Instead, the storage systems can be ventilated through the hybrid drying system 100 via a general exhaust of a building in which the storage systems are located. Liquid nitrogen (LN2) consumption may be reduced by 60 percent to 90 percent. CO2 may also be reduced, thereby improving sustainability. The hybrid drying system 100 may provide significant cost savings. Furthermore, operations can be sustained with nitrogen bottles instead of nitrogen truck deliveries.

An integrated hybrid dryer and storage system results in an “all-in-one system” and eliminates the need for retrofitting. The hybrid drying system 100 may have a minimal impact to install schedule, reducing start-up time to less than 6 months. The hybrid drying system 100 is ideal for bulk storage with strict quality requirements such as less than 5 percent RH, less than 500 ppm O₂, and ESD approved. The hybrid drying system 100 may have a high efficiency (e.g., less than 15 min process time), and may have a linear configuration (see below) with minimal static pressure. The hybrid drying system 100 may occupy the bottom tray of the storage system or occupy a space below the trays so that it does not add to the storage system's footprint.

The hybrid drying system 100 can record technical data over an extended period of time to determine if air quality requirements can or are being met. The hybrid drying system 100 reduces consumable such as nitrogen, improves safety, economizes the use of existing or new climate controlled storage systems, and ensures ESD compliance.

Commercial applications include large automated storage systems, and HEMSS dryers can be used as HVAC systems for clean rooms. Potential end users include entities that need large-scale environmentally controlled automated storage systems including defense contractors, semi-conductor tech, telemetry, and surface mount technology (SMT) industry.

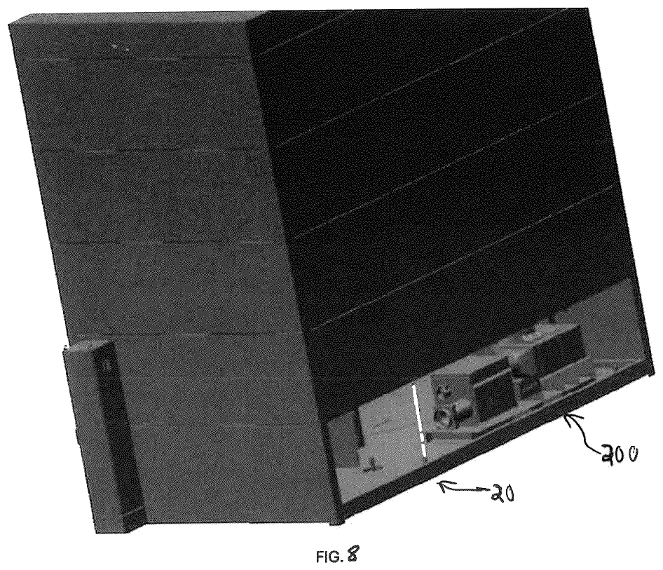

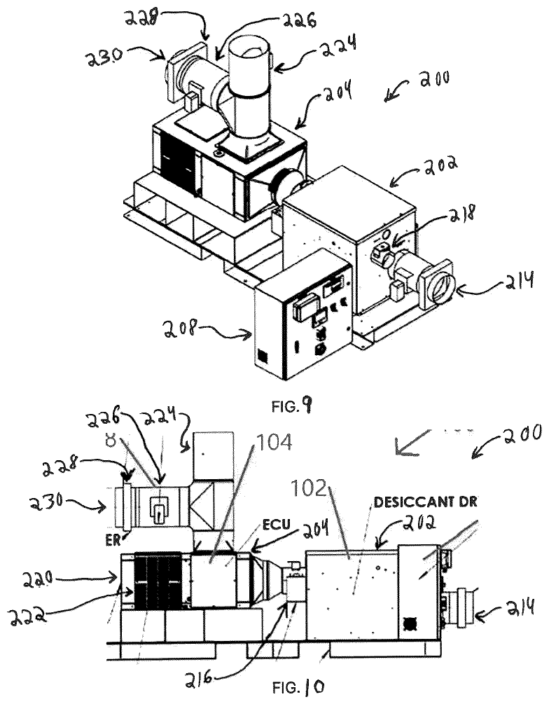

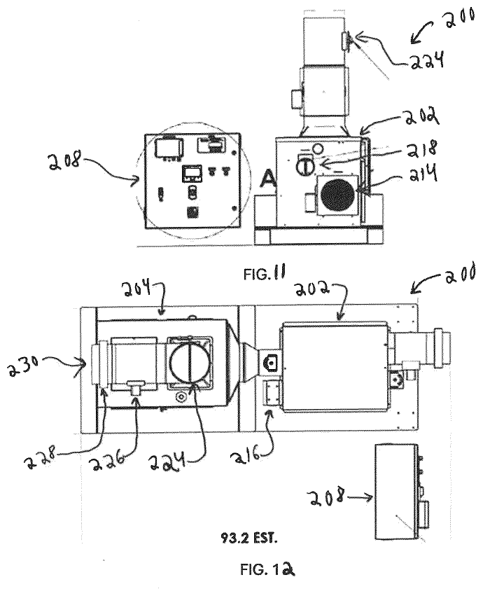

Turning to FIGS. 8-12, hybrid drying system 200 constructed in accordance with another embodiment will be described. The hybrid drying system 200 is shown installed in a vertical lift module 20 but may also be positioned externally, such as mounted on a platform beside the vertical lift module 20.

The hybrid drying system 200 broadly comprises a desiccant dryer 202, an ECU 204 including a condenser, and a control panel 208 including a plurality of sensors and a smart nitrogen control system. The hybrid drying system 200 may also include a fire suppression controller, a process air inlet 214, a react air inlet 216, a react air discharge 218, a condenser air inlet 220, condenser air discharge 222, a manual exhaust damper 224, a dynamic isolation damper 226, a fire damper 228, and a process air discharge 230.

The above components are similar to the corresponding components of the hybrid drying system 100 except at least the desiccant dryer 202, the ECU 204 and the condenser 206, and the ductwork for the manual exhaust damper 224 are positioned in a linear configuration to minimize static pressure therebetween. For example, the connecting ductwork between the desiccant dryer 202 and the ECU 204 is straight with no bends, turns, elbows, or the like. That is, the desiccant dryer 202 and the ECU 204 may be connected inline thereby optimizing airflow therebetween. In another instance, a ductwork bend is eliminated by orienting the T-joint leading to the manual exhaust damper 224 such that the T-joint such that the ECU 204, T-joint, and manual exhaust damper 224 are aligned with each other, and the T-joint acts as an elbow between the ECU 204 and the process air discharge 230. The linear configuration does not mean that no airflow redirections exist and all components are aligned with each other, but instead means that bends, turns, elbows, and other airflow restrictions are minimized primarily due to a layout of the components. Such a layout sacrifices compactness (increases floor space) for improved airflow. This embodiment is also heat reject compliant.

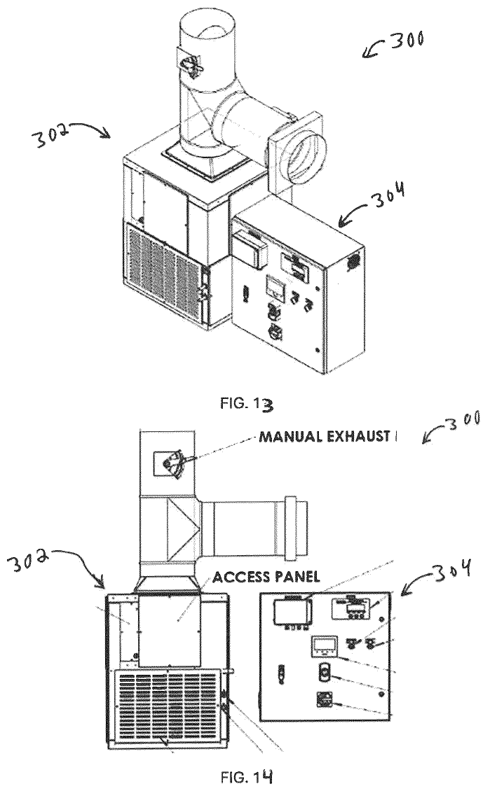

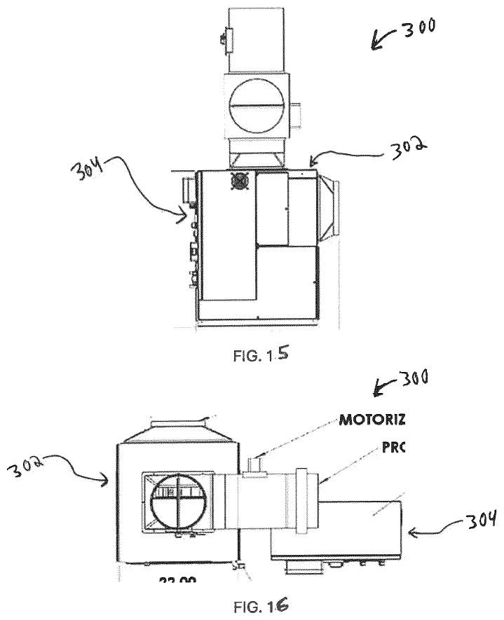

Turning to FIGS. 13-16, a standalone ECU and nitrogen system 300 may have a vertical configuration and may be air-boosted and water cooled and adaptable for N2 control. The standalone ECU and nitrogen system 300 may include an ECU 302 and a control panel 304 including a smart nitrogen control system similar to the ECUs and smart nitrogen control systems described above. The standalone ECU and nitrogen system 300 may be ideal for large storage systems with moderate climate control requiring less than between 20 percent and 45 percent RH and less than 500 ppm oxygen level. This embodiment may have a small footprint (e.g., 132 lbs) and may be easily mountable.

### Additional Considerations

This description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. This description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Throughout this specification, plural instances may implement components, operations, or structures described as a single instance. Although individual operations of one or more methods may be illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application- specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises”, “comprising”, “includes”, “including”, “has”, “having”, or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 114(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A hybrid drying system for treating process air entering a climate controlled system, the hybrid drying system comprising:
a desiccant dryer configured to remove moisture from the process air;
an environmental control unit (ECU) including a condenser fluidly connected to the desiccant dryer and configured to further remove moisture from the process air; and
a smart nitrogen control system configured to reduce an oxygen level of the process air via selective injection of nitrogen into the process air.

2. The hybrid drying system of claim 1, further comprising an oxygen sensor, wherein the smart nitrogen control system is configured to activate nitrogen injection when the oxygen level is greater than 500 parts per million (ppm) as detected by the oxygen sensor.

3. The hybrid drying system of claim 1, wherein the smart nitrogen control system is configured to reduce the oxygen level of the process air to less than 500 ppm.

4. The hybrid drying system of claim 1, wherein the condenser is configured to reduce a moisture level of the process air to less than 18 percent relative humidity independently from the desiccant dryer.

5. The hybrid drying system of claim 1, wherein the desiccant dryer and the condenser are configured to reduce a moisture level of the process air to less than 5 percent relative humidity.

6. The hybrid drying system of claim 1, further comprising:
a process air discharge opening configured to release the treated process air to the climate controlled system; and
a manual exhaust damper connected between the ECU and the process air discharge via a T-joint.

7. The hybrid drying system of claim 6, further comprising a fire damper near the process air discharge opening.

8. The hybrid drying system of claim 6, further comprising a dynamic isolation damper connected between the ECU and the fire damper.

9. The hybrid drying system of claim 1, wherein the hybrid drying system configured to be retrofitted to the climate controlled system.

10. The hybrid drying system of claim 1, wherein the ECU is positioned above the desiccant dryer and the ECU is fluidly connected to the desiccant dryer via a non-linear duct.

11. The hybrid drying system of claim 10, wherein the ECU is connected to the desiccant dryer via a duct having two elbows.

12. The hybrid drying system of claim 1, further comprising a temperature sensor for detecting a temperature of the process air and a controller configured to control the condenser to change the temperature of the process air based on an output of the temperature sensor.

13. The hybrid drying system of claim 1, further comprising a relative humidity sensor configured to detect a relative humidity of the process air and a controller configured to control the condenser to change the relative humidity of the process air based on an output of the relative humidity sensor.

14. The hybrid drying system of claim 1, further comprising an on/off switch for manually activating the hybrid drying system and an emergency off (EMO) switch for automatically deactivating the hybrid drying system upon detection of an emergency condition.

15. The hybrid drying system of claim 1, wherein the hybrid drying system is at least one of air cooled and water cooled.

16. The hybrid drying system of claim 1, wherein the desiccant dryer is a regenerative desiccant dryer including batches of operative material.

17. A hybrid drying system for treating process air entering a climate controlled system, the hybrid drying system comprising:
a desiccant dryer configured to remove moisture from the process air;
an environmental control unit (ECU) including a condenser fluidly connected to the desiccant dryer and configured to further remove moisture from the process air, the ECU being connected inline with the desiccant dryer thereby optimizing airflow therebetween; and
a smart nitrogen control system configured to reduce an oxygen level of the process air via selective injection of nitrogen into the process air.

18. The hybrid drying system of claim 17, the smart nitrogen control system including an oxygen sensor, wherein the smart nitrogen control system is configured to activate nitrogen injection when the oxygen level is greater than 500 parts per million (ppm) as detected by the oxygen sensor.

19. The hybrid drying system of claim 17, further comprising:
a process air discharge opening configured to release the treated process air to the climate controlled system; and
a manual exhaust damper connected between the ECU and the process air discharge via a T-joint, the manual exhaust damper being connected inline with the condenser, and the process air discharge opening being connected to the ECU via the T-joint so that airflow from the ECU passes straight through the T-joint to the manual exhaust damper and bends through the T-joint to the to the process air discharge opening.

20. A standalone environmental control unit (ECU) and nitrogen system for treating process air entering a climate controlled system, the standalone ECU and nitrogen system comprising:
an ECU including a condenser configured to remove moisture from the process air; and
a control panel including:
a relative humidity sensor configured to detect a relative humidity of the process air, wherein the control panel is configured to control the condenser to a moisture level of the process air based on an output of the relative humidity sensor;
an on/off switch for manually activating the standalone ECU and nitrogen system;
an emergency off (EMO) switch for automatically deactivating the standalone ECU and nitrogen system upon detection of an emergency condition; and
a smart nitrogen control system configured to reduce an oxygen level of the process air via selective injection of nitrogen into the process air,
wherein the condenser is configured to reduce the moisture level of the process air to less than 18 percent relative humidity.
